(19) United States
(12) Patent Application Publication
(10) Pub. No.: US 2024/0118030 A1
(43) Pub. Date: Apr. 11, 2024

(54) TWO-CHAMBER FURNANCE FOR ALUMINUM RECYCLING

(71) Applicant: Jasper GmbH, Quickborn (DE)

(72) Inventors: Jörn Kurt Ludewig, Elmshorn (DE); Jens-Ole Jasper, Brande-Hörnerkirchen (DE)

(21) Appl. No.: 18/480,043

(22) Filed: Oct. 3, 2023

(30) Foreign Application Priority Data
Oct. 6, 2022 (DE) 10 2022 125 816.5

(51) Int. Cl. F27B 3/04; C22B 7/00; C22B 21/00; F23D 14/66; F27B 3/26; F27D 13/00; F27D 17/00

(52) U.S. Cl. CPC F27B 3/045; C22B 7/003; C22B 21/0092; F23D 14/66; F27B 3/26; F27D 13/002; F27D 17/004; F27B 3/205

(57) ABSTRACT

The disclosure relates to a melting furnace, for example a two-chamber furnace, for the recovery of aluminum from aluminum scrap. This has a scrap chamber (2), with a dry hearth (6), the surface of which provided for receiving aluminum scrap is arranged above the surface of an aluminum melt (7) located in the scrap chamber (2) during operation of the melting furnace (1), and a heating chamber (3), which has at least one burner (9) for fuel firing, the heating chamber (3) and the scrap chamber (2) being separated from one another by a partition wall (11), the partition wall (11) having at least one opening (12) for recirculation of the aluminum melt (7) between the heating chamber (3) and the scrap chamber (2). Further, a refractory lining of the surface of the dry hearth (6) and/or a refractory lining of the inner wall of the scrap chamber (2) in the region of the dry hearth (6) have channels (18) which can be acted upon by hot gas and are designed to absorb heat from the hot gas and to release it to the aluminum scrap located on the surface of the dry hearth (6) for its thermal pretreatment.

### PRIORITY CLAIM

This application claims priority to German patent application DE 10 2022 125 816.5 filed Oct. 6, 2022, which is expressly incorporated by reference herein.

### FIELD OF THE DISCLOSURE

The disclosure relates to a melting furnace, for example a two-chamber furnace, for the recovery of aluminum from aluminum scrap, comprising:
a scrap chamber having a dry hearth, the surface of which intended to receive aluminum scrap is arranged above the surface of an aluminum melt located in the scrap chamber during operation of the melting furnace, and
a heating chamber having at least one burner for fuel firing, the heating chamber and the scrap chamber being separated from each other by a partition wall, the partition wall having at least one opening for recirculation of aluminum melt between the heating chamber and the scrap chamber.

### BACKGROUND

A prior art two-chamber furnace has two chambers, namely a scrap chamber into which aluminum scrap is fed in batches for thermal pretreatment, and a heating chamber for heating the aluminum melt. In the heating chamber, the heat required for melting is provided by fuel firing using one or more burners, e.g. gas burners. One or more burners are also provided in the scrap chamber for pretreatment. By means of a partition wall between the scrap chamber and the heating chamber different temperatures can be set in the two chambers.

The aluminum scrap of a batch is first loaded onto a dry hearth located in the scrap chamber, the surface of which is above the surface of the melt. Thermal pretreatment takes place on the dry hearth. After pretreatment, the aluminum scrap is pushed off the dry hearth and falls from there into the melt, where it is melted down and thus added to the melt.

The aluminum scrap may be, for example, can scrap. Can scrap is either used aluminum beverage cans or return material from industrial production. However, the aluminum scrap can also be any other scrap that is to be melted down, e.g. in the form of shredder material, profiles, machine parts or other return scrap.

Aluminum scrap is often contaminated or has an undesirable amount of organic contamination on the surface. The aluminum scrap may be contaminated with oils, greases, paints, coatings or other organic contaminants. The adhesions, e.g. the coatings of beverage cans, usually consist of hydrocarbon compounds. These are removed as far as possible during thermal pretreatment. Thermal pretreatment in the form of pyrolysis has become established. The pyrolysis gas produced during pretreatment can be burned in the furnace to heat it, which improves energy efficiency.

The aluminum scrap on the dry hearth is heated in the scrap chamber from above or from the side by means of the burner provided for this purpose. It should be noted that the pretreatment temperature must not be too high, otherwise the metal yield will drop. A pretreatment temperature of 500-570° C. is aimed for. The time available for pretreatment is limited due to the throughput to be achieved. Since the scrap has thus far only been heated on its free surfaces at a not too high temperature over a limited period of time, the scrap is not sufficiently heated on the underside where it rests on the surface of the dry hearth. The scrap, which is thus partially not sufficiently preheated, is only incompletely freed from organic adhesions and cools the liquid melt in the furnace too much. Energy consumption is increased accordingly. Residues of non-pyrolyzed adhesions react with the melt and lead to impurities which are present in solid form (e.g. aluminum carbide, aluminum oxide). This leads to a loss of metal. The throughput is not optimal.

### SUMMARY

The disclosure relates to a melting furnace, for example a two-chamber furnace, for the recovery of aluminum from aluminum scrap, comprising:
a scrap chamber having a dry hearth, the surface of which intended to receive aluminum scrap is arranged above the surface of an aluminum melt located in the scrap chamber during operation of the melting furnace, and
a heating chamber having at least one burner for fuel firing, the heating chamber and the scrap chamber being separated from each other by a partition wall, the partition wall having at least one opening for recirculation of aluminum melt between the heating chamber and the scrap chamber.

### BRIEF DESCRIPTION OF THE DRAWINGS

FIG. 1: shows schematically a melting furnace according to the disclosure in sectional top view,

FIG. 2: shows melting furnace from FIG. 1 in lateral sectional view (section line A-A in FIG. 1).

### DESCRIPTION OF THE SPECIFIC EMBODIMENTS

The disclosure relates to a melting furnace, for example a two-chamber furnace, for the recovery of aluminum from aluminum scrap, comprising:
a scrap chamber having a dry hearth, the surface of which intended to receive aluminum scrap is arranged above the surface of an aluminum melt located in the scrap chamber during operation of the melting furnace, and
a heating chamber having at least one burner for fuel firing, the heating chamber and the scrap chamber being separated from each other by a partition wall, the partition wall having at least one opening for recirculation of aluminum melt between the heating chamber and the scrap chamber. Further, a refractory lining of the surface of the dry hearth and/or a refractory lining of the (lateral) inner wall of the scrap chamber in the region of the dry hearth have channels which can be acted upon by hot gas and are designed to absorb heat from the hot gas and to release it to the aluminum scrap located on the surface of the dry hearth for its thermal pretreatment.

The melting furnace is lined with refractory materials, as usual. The materials used for the refractory lining of the inner furnace walls are so-called refractory materials. These are usually non-metallic, mainly ceramic materials, which, depending on the application, can be used above 600° C. to over 1700° C. and can therefore be in direct thermal contact with the high-temperature processes (pretreatment, melting) in the furnace.

According to claim 1, the disclosure proposes that the refractory lining of the surface of the dry hearth and/or the inner wall of the scrap chamber in the area of the dry hearth is designed with channels through which hot gas is passed. As a result, the refractory lining is heated and the heat is transferred to the scrap located on the dry hearth during pretreatment. As a result, the aluminum scrap can be heated not only from its free surfaces, as was previously the case, but also from below and optionally additionally from the side. The aluminum scrap is thus heated more uniformly overall. This results in more complete pyrolysis compared with the state of the art. In addition, the aluminum scrap can be more uniformly and completely thermally pretreated without exceeding temperatures at which undesirable oxidation of the aluminum occurs. Accordingly, the temperature of the aluminum melt drops less when the scrap is transferred to the melt after pretreatment. As a result, the throughput of the furnace and its energy efficiency can be improved compared with the prior art.

Embodiments and further developments result from the dependent claims. It should be noted that the features listed individually in the claims can also be combined with one another in any desired and technologically useful manner and thus reveal further embodiments of the disclosure.

In one embodiment of the melting furnace, the scrap chamber also has a burner for fuel firing. By means of the burner, the aluminum scrap located on the dry hearth can be heated to for example 500-570° C. during the thermal pretreatment, while parallel heating takes place from below and/or from the side by means of the hot gas fed through the channels in the refractory lining. The aluminum scrap is heated uniformly accordingly.

In a further embodiment, the at least one burner of the heating chamber and/or the scrap chamber have an air supply for supplying air as combustion air and an exhaust gas recirculation for discharging exhaust gas, the air supply and the exhaust gas recirculation being connected in a heat-transferring manner by a heat exchanger which is set up to absorb heat from the exhaust gas and to discharge it to the air. In this embodiment, the burners in the heating chamber and/or scrap chamber are, in other words, regenerative burners. The high amount of heat contained in the discharged exhaust gas is recovered by means of the heat exchanger to preheat the combustion air supplied to the burner. This saves a considerable amount of fuel. Suitable regenerative burners are described, for example, in EP 3 633 267 A1, the full contents of which are included here in relation to the burner design.

In one embodiment, the air supply between the heat exchanger and the burner has a branch via which a partial flow of the air can be supplied to the channels as hot gas. In regenerative burners, the exhaust gas used to preheat the combustion air in the heat exchanger has a higher specific heat than air. Therefore, to achieve thermal equilibrium in the heat exchanger, a larger volume of air must be used anyway than is required for fuel firing. The excess hot air is previously blown off into the environment. The air temperature at the outlet of the heat exchanger is about 900° C. It is an idea of the disclosure to act upon the channels in the refractory lining of the dry hearth and/or the inner wall of the scrap chamber in the area of the dry hearth with this excess hot air as hot gas in order to carry out or support the thermal pretreatment of the scrap located on the dry hearth.

Accordingly, no additional energy needs to be expended for the generation of the hot gas. As a result of the disclosure, the heat previously released into the environment is put to use in the furnace. The result is that the melting furnace has a higher throughput with less energy input. The approach of the disclosure can be used to design the melting furnace smaller at a specified throughput, with correspondingly lower energy consumption.

In one embodiment, the branch is variably adjustable with respect to the ratio of the air flow supplied to the burner and the partial flow. The relative adjustment of the two air flows can be used to adjust the amount of combustion air supplied in accordance with the heat requirement as a function of the amount of fuel to be burned.

It is expedient to provide a hot gas outlet through which the hot gas (cooled after heat release during pretreatment of the aluminum scrap) leaves the melting furnace after flowing through the channels into the environment.

In one possible embodiment, a control/regulating unit is provided which is set up to regulate the temperature of the air after it has passed through the heat exchanger to 500-900° C. by controlling the supplied air flow. The air flow is expediently controlled automatically to achieve thermal equilibrium in the heat exchanger at a desired temperature level. The exhaust gas temperature is typically 800-900° C. This represents the upper limit for the temperature of the air after it has passed through the heat exchanger. The control/regulation unit can expediently be further arranged to regulate the oven temperature in the dry hearth region to 400-600° C., for example 500-570° C. This temperature range is ideal for the pretreatment of the aluminum scrap so that pyrolysis takes place as completely as possible, but oxidation of the aluminum does not occur.

In another embodiment, the scrap chamber has a loading door through which the surface of the dry hearth can be loaded with aluminum scrap in batches, for example by means of a charging device provided specifically for this purpose or by means of a wheel loader. Through the loading door, the aluminum scrap can also be advanced further after thermal pretreatment in order to transfer it from the surface of the dry hearth into the aluminum melting bath.

### DETAILED DESCRIPTION OF THE DRAWINGS

Further features and details of the disclosure will be apparent from the following description and from the drawings, which show examples of embodiments of the disclosure. Corresponding objects or elements are provided with the same reference signs in all figures.

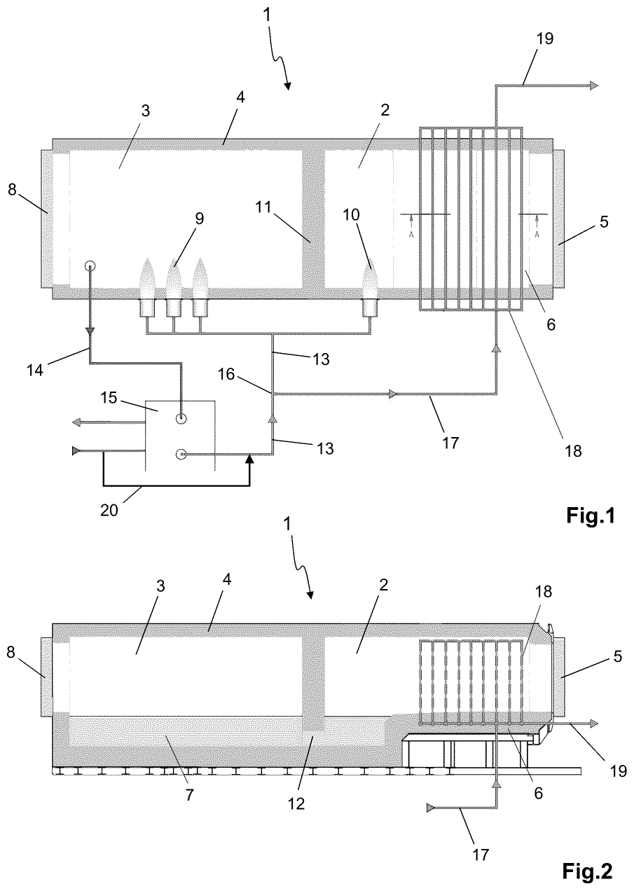

FIG. 1 shows a sectional view, viewed from above, of a melting furnace 1 designed as a two-chamber furnace for recovering aluminum from aluminum scrap. FIG. 2 shows a lateral sectional view.

The melting furnace 1 has a scrap chamber 2 and a heating chamber 3 with a wall 4 sealed from the outside atmosphere, which is provided with a refractory lining made of a mineral refractory material that is temperature resistant to over 1200° C.

The scrap chamber 2 is set up for pretreatment of the aluminum scrap (not shown) before melting. The scrap chamber 2 has a lockable loading door 5 at the front end, through which the scrap chamber 2 can be loaded with the aluminum scrap in batches. A dry hearth 6 is located in the scrap chamber 2, on the surface of which the aluminum scrap is deposited. Liquid aluminum melt 7 is connected to the dry hearth 6 on the opposite side with respect to the loading door 5 during operation. The surface of the dry hearth 6 is above the level of the aluminum melt 7.

The heating chamber 3 extends, as seen from the loading door 5, behind the scrap chamber 2, the heating chamber 3 having a further door 8 opposite the loading door 5, through which the heating chamber 3 is accessible, e.g. for cleaning and maintenance purposes. The aluminum melt 7 extends into the heating chamber 3. Burners 9 for fuel firing (with gas or any other fuel) are provided in the heating chamber. These are directed into a heating zone above the aluminum melt 7. A further burner 10 is provided in the scrap chamber 2.

The scrap chamber 2 and the heating chamber 3 are arranged one behind the other in the longitudinal direction and are separated from each other by means of a partition wall 11. This is a partition wall which projects into the aluminum melt 7 from above during operation of the melting furnace 1. The partition wall 11 has, below the level or the surface of the aluminum melt 7, at least one opening 12 for recirculating the aluminum melt 7 between the heating chamber 3 and the scrap chamber 2.

The dry hearth 6 in the scrap chamber 2 is loaded with aluminum scrap in batches by means of an automatic charging device not shown or a wheel loader. The scrap chamber 2 is heated by means of the burner 10 (and by recirculation of the aluminum melt 7 from the heating chamber 3 into the scrap chamber 2) to a predetermined temperature, for example about 570° C., for thermal pretreatment of the aluminum scrap, the temperature being such calculated that undesirable oxidation of the aluminum scrap does not occur. The organic deposits on the aluminum scrap are converted into a pyrolysis gas.

The burners 9 of the heating chamber 3 and also the burner 10 of the scrap chamber have an air supply 13 for supplying air as combustion air and an exhaust gas recirculation 14 for discharging exhaust gas produced during fuel firing. The air supply 13 and the exhaust gas recirculation 14 are connected to each other in a heat-transferring manner by a heat exchanger 15. The heat exchanger 15 absorbs heat from the exhaust gas flow before it is discharged into the environment and transfers the heat to the air supplied from outside. In the process, the air in the air supply 13 at the outlet of the heat exchanger 15, i.e. the air supplied to the burners 9, 10, is heated to approximately 800-900° C. The high amount of heat contained in the discharged exhaust gas stream 14 is recovered by means of heat exchanger 15 to preheat the combustion air supplied to burners 9, 10.

The air supply 13 has a branch 16 between the heat exchanger 15 and the burners 9, 10, through which a partial stream 17 of air can be supplied to channels 18 as hot gas. The refractory lining of the surface of the dry hearth 6 and of the inner wall of the scrap chamber 2 in the area of the dry hearth 6 is designed with channels 18 through which the hot air of the partial flow 17 is guided before it leaves the melting furnace 1 via a hot gas outlet 19. As a result, the refractory lining in the area of the dry hearth 6 is heated and the heat is transferred to the aluminum scrap located on the dry hearth 6 during pretreatment. As a result, the aluminum scrap is heated not only from the burner 10, i.e., essentially from above, but also from below and from the side. The aluminum scrap is thus heated more uniformly overall, and optimum pretreatment conditions are created.

A bypass 20 is provided to allow cool gas (ambient air) with a variable proportion to be admixed to the hot gas in the partial flow 17. This enables improved temperature control of the dry hearth 6 and/or the side walls in the area of the dry hearth 6. Appropriate control valves (not shown) are used for the variable admixture.

To achieve thermal equilibrium in the heat exchanger 15, a larger volume of air must be used than is required for the fuel firing. According to the disclosure, the resulting excess of hot air is used to act on the channels 18 in the refractory lining of the dry hearth 6 and on the inner wall of the scrap chamber 2 in the area of the dry hearth 6. The heat thus originally recovered from the exhaust gas stream 14 is used to carry out or support the thermal pretreatment of the scrap located on the dry hearth 6.

After completion of the pretreatment phase, the pretreated aluminum scrap charge is pushed from the dry hearth 6 into the aluminum melting bath 7, where the scrap is melted down and combines with the melt 7. The scrap is expediently advanced through the loading door 5 by means of a wheel loader or charging device.

The improved pretreatment according to the disclosure achieves a more complete pyrolysis compared to the prior art. In addition, the aluminum scrap can be more uniformly and completely thermally pretreated without exceeding temperatures at which undesirable oxidation occurs. Accordingly, the temperature of the aluminum melt 7 decreases less when the scrap is transferred to the melt after pretreatment. As a result, the throughput of the melting furnace 1 and its energy efficiency can be improved compared to the prior art.

The disclosure provides an improved melting furnace which allows effective pretreatment of aluminum scrap.

### LIST OF REFERENCE SIGNS

1 melting furnace
2 scrap chamber
3 heating chamber
4 furnace wall
5 loading door
6 dry hearth
7 aluminum melt
8 another door
9 burner heating chamber
10 burner scrap chamber
11 partition wall
12 recirculation opening
13 air supply
14 exhaust gas recirculation
15 heat exchanger
16 branch
17 partial flow
18 channels
19 hot gas outlet
20 bypass

1. Melting furnace, for example two-chamber furnace, for recovering aluminum from aluminum scrap, having:
a scrap chamber (2) with a dry hearth (6), the surface of which provided for receiving aluminum scrap is arranged above the surface of an aluminum melt (7) located in the scrap chamber (2) during operation of the melting furnace (1), and
a heating chamber (3) having at least one burner (9) for fuel firing, the heating chamber (3) and the scrap chamber (2) being separated from each other by a partition wall (11), the partition wall (11) having at least one opening (12) for recirculation of the aluminum melt (7) between the heating chamber (3) and the scrap chamber (2),
characterized in
in that a refractory lining of the surface of the dry hearth (6) and/or a refractory lining of the inner wall of the scrap chamber (2) in the region of the dry hearth (6) have channels (18) which can be acted upon by hot gas and are designed to absorb heat from the hot gas and to release it to the aluminum scrap located on the surface of the dry hearth (6) for its thermal pretreatment.

2. Melting furnace according to claim 1, characterized in that the scrap chamber (2) also has a burner (10) for fuel firing.

3. Melting furnace according to claim 1, characterized in that the at least one burner (9, 10) of the heating chamber (3) and/or the scrap chamber (2) has an air supply (13) for supplying air as combustion air and an exhaust gas recirculation (14) for discharging exhaust gas, the air supply (13) and the exhaust gas recirculation being connected in a heat-transferring manner by means of a heat exchanger (15) which is set up to absorb heat from the exhaust gas and to discharge it to the air.

4. Melting furnace according to claim 3, characterized in that the air supply (13) between the heat exchanger (15) and the burner (9, 10) has a branch (16) via which a partial flow (17) of the air can be supplied to the channels (18) as hot gas.

5. Melting furnace according to claim 4, characterized in that the branch (16) is variably adjustable with respect to the ratio of the air flow supplied to the burner (9, 10) and the partial flow (17).

6. Melting furnace according to claim 3, characterized by a control/regulating unit which is set up to regulate the furnace temperature in the region of the dry hearth (6) to 400-600° C., for example 500-570° C.

7. Melting furnace according to claim 1, characterized by a hot gas outlet (19) through which the hot gas leaves the melting furnace (1) into the environment after flowing through the channels (18).

8. Melting furnace according to claim 1, characterized in that the scrap chamber (2) has a loading door (5) through which the surface of the dry hearth (6) can be loaded with aluminum scrap in batches.
